(19) United States
(12) Patent Application Publication
(10) Pub. No.: US 2012/0323797 A1
(43) Pub. Date: Dec. 20, 2012

(54) SYSTEM FOR BACK TRACING A COMPONENT USED IN MANUFACTURE

(75) Inventors: Wayne Hon FU, Mountain View, CA (US); Daniel Ding, San Jose, CA (US)

(73) Assignee: Apple Inc., Cupertino, CA (US)

(21) Appl. No.: 13/223,100

(22) Filed: Aug. 31, 2011

Related U.S. Application Data
(60) Provisional application No. 61/498,078, filed on Jun. 17, 2011.

(51) Int. Cl. G06Q 10/00; G06F 17/30

(52) U.S. Cl. 705/303; 235/375

(57) ABSTRACT

A system and method for back tracing a component used in manufacture is described.

This application claims priority to and the benefit under 35 U.S.C. §119(e) of U.S. Provisional Application Ser. No. 61/498,078, filed Jun. 17, 2011, entitled SYSTEM FOR BACK TRACING A COMPONENT USED IN MANUFACTURE by Fu et al, the entire disclosure of which is hereby incorporated herein by reference.

### BACKGROUND OF THE INVENTION

1. Field of the Invention

The present invention relates generally to maintaining the traceability of manufacturing components. More specifically, tracking the origin of light emitting diodes (LEDs) affixed to a lightbar using a component tracking database for tracking the position of LEDs affixed to a lightbar during a lightbar manufacturing process is disclosed.

2. Related Art

One of the more recent innovations in display technology is the use of LEDs to provide back lighting for a liquid crystal display (LCD). Conventional LCDs generally relied on fluorescent backlighting; however by switching to an array of LEDs in the form of lightbar assembly, manufacturers could produce displays at lower cost, with longer life, improved vibration resistance, lower operational voltage, and precise control over display intensity. The lightbar assembly can includes a number of LEDs attached at regular intervals along the length of a lightbar substrate. A substantially uniform backlight for the LCD is provided when a lightbar assembly is combined with other lightbar assemblies into an array. A lightbar substrate is a strip that can be either flexible or rigid designed to support a number of LEDs. Manufacturing lightbar assemblies involves attaching a number of LEDs to each lightbar substrate. Because LEDs can come from a wide variety of suppliers, from various production lots and production lines, occasionally, a defective device can be installed and only during a quality check, or more ominously in the event of a field failure, is the defective device discovered. Unfortunately, not knowing from which production lot or production line the defective device originated makes it extremely difficult to track down and identify devices from the same production lot or line that may also be defective. Therefore, it would be beneficial to have a simple way to identify which suppliers or supply lines were responsible for specific bad batches of components. Unfortunately since the identification indicia of each LED is generally located on the backside, once it is installed on the lightbar it becomes difficult to read without going through a time consuming and potentially destructive removal effort. Removing each faulty LED on every returned or faulty lightbar, is both time consuming and impractical.

Therefore an efficient and cost effective approach to maintaining the traceability of specific components is desired.

### SUMMARY OF THE DESCRIBED EMBODIMENTS

This paper describes a system for tracking the origin of electronic components placed in an electronic device.

Generally a system for back tracing a component used in manufacture is described including the following: a processor; a component information gathering device arranged to acquire component information during an assembly operation, the component information including component identification information and component origin information corresponding to the component; a substrate information gathering device arranged to acquire substrate information during the assembly operation, the substrate information including substrate identification information corresponding to a substrate on which the component is attached during the assembly operation; and a data storage device coupled to the component information gathering device and the substrate information gathering device and the processor. During the assembly operation the processor instructs the component information gathering device to acquire the component information at least a portion of which is stored in the data storage device, instructs the substrate information gathering device to acquire the substrate information associated with the substrate on which the component is attached at least a portion of which is stored in the data storage device, and links the substrate information and the corresponding component information stored in the data storage device to form a data bundle, where the data bundle can be used to back trace the component subsequent to the completion of the assembly operation.

In one aspect of the described embodiments, the components can take the form of light emitting diodes (LED) that are attached and electrically connected to a lightbar substrate to form a lightbar assembly. The lightbar assembly can, in turn, be used separately or in conjunction with other lightbar assemblies to provide a backlight for a transmissive type display such as an LCD.

A method for using identification of a defective display element in a light bar assembly in a display device for issuing a recall notice is disclosed. The method is performed by carrying out at least the following operations. Receiving information of a light bar assembly having at least one defective display element attached thereto, the information including a physical location of the defective display element, the information including display element information and light bar information, using the received information to query a component tracking database to obtain defective display element information, using the defective display element information to obtain information of display elements related to the defective display element, using the related display element information to identify at least another display device having at least one related display element included therein, determining a defect mode of the defective display element, and issuing the recall notice to the at least another display device of the presence of the identified related display element only when the defect mode is determined to be unacceptable.

An assembly method is disclosed. The assembly method is performed by receiving at least one substrate and at least one component for mounting upon the substrate, acquiring component information that includes at least identification information and component origin information corresponding to the component, acquiring substrate information including substrate identification information, passing at least some of the acquired information to a data store, attaching the component to the substrate at a pre-defined location on the substrate, passing pre-defined location information to the data store, and linking the substrate information and the pre-defined location information to form a data bundle. In one embodiment, the data bundle is used to back trace the component subsequent to the completion of the assembly method.

Non-transitory computer readable medium for storing computer code executable by a processor for using identification of a defective display element in a light bar assembly in a display device for issuing a recall notice. The computer readable medium includes at least computer code for receiving information of a light bar assembly having at least one defective display element attached thereto, the information including a physical location of the defective display element, the information including display element information and light bar information, computer code for using the received information to query a component tracking database to obtain defective display element information, computer code for using the defective display element information to obtain information of display elements related to the defective display element, computer code for using the related display element information to identify at least another display device having at least one related display element included therein, computer code for determining a defect mode of the defective display element, and computer code for issuing the recall notice to the at least another display device of the presence of the identified related.

### BRIEF DESCRIPTION OF THE DRAWINGS

The invention and the advantages thereof may best be understood by reference to the following description taken in conjunction with the accompanying drawings.

FIGS. 1A and 1B show a visual representation of the data that is recorded into the relational component tracking database.

FIGS. 2A and 2B show the how the component identification information can be stored before it is associated together in the component tracking database.

FIGS. 2C and 2D show two embodiments of the component tracking database in accordance with the described embodiments.

FIG. 3 shows a system for manufacturing a lightbar, where the component identification information is recorded and associated with the component tracking database.

FIG. 4 shows a process for recording individual LED identification information and associating it with a position on a specific lightbar substrate in accordance with the described embodiments.

FIGS. 5-7 visualize the process of manufacturing and recording the subcomponent information of a lightbar into the component tracking database.

FIG. 8 shows a process for testing a completed lightbar after assembly.

FIG. 9 shows a process for deciding whether faulty LED batches or lots are faulty enough to initiate a recall.

### DETAILED DESCRIPTION OF EXAMPLE EMBODIMENTS

In the following description, numerous specific details are set forth to provide a thorough understanding of the present invention. It will be apparent, however, to one skilled in the art that the presently described embodiments may be practiced without some or all of these specific details.

Conventional manufacturing processes involve assembling complex devices such as electronic devices from a large variety of different component manufacturers. Often times a specific part may be produced by different factories, or even completely different corporations. Quality control can vary significantly between the component manufacturers. Without some sort of method for tracking the origin of the parts, it is very difficult to make informed decisions about which component suppliers are responsible for a bad component in a particular electronic device.

For the remainder of this discussion the lightbar manufacturing process will be used to illustrate some of the difficulties involved with tracking component parts. Conventional manufacturing processes for populating lightbars with LEDs do not associate individual LED information with the lightbar substrate to which it is attached. Since the identification indicia of each LED is generally located on the backside, once it is installed on the lightbar it becomes difficult to read without going through a time consuming removal effort. A solution to this problem can involve creating a component tracking database which associates a parent lightbar substrate with each individual LED's identification indicia and position on the lightbar substrate. This allows, for example, the origin of a faulty LED to be determined quite quickly, simply by scanning the identification indicia located on the faulty lightbar. Although the below examples only show standard barcodes and 2D Matrix barcodes to identify the component parts, any other identification indicia, such as RFID, bokodes, or any other equivalent should also be considered included in the described embodiment.

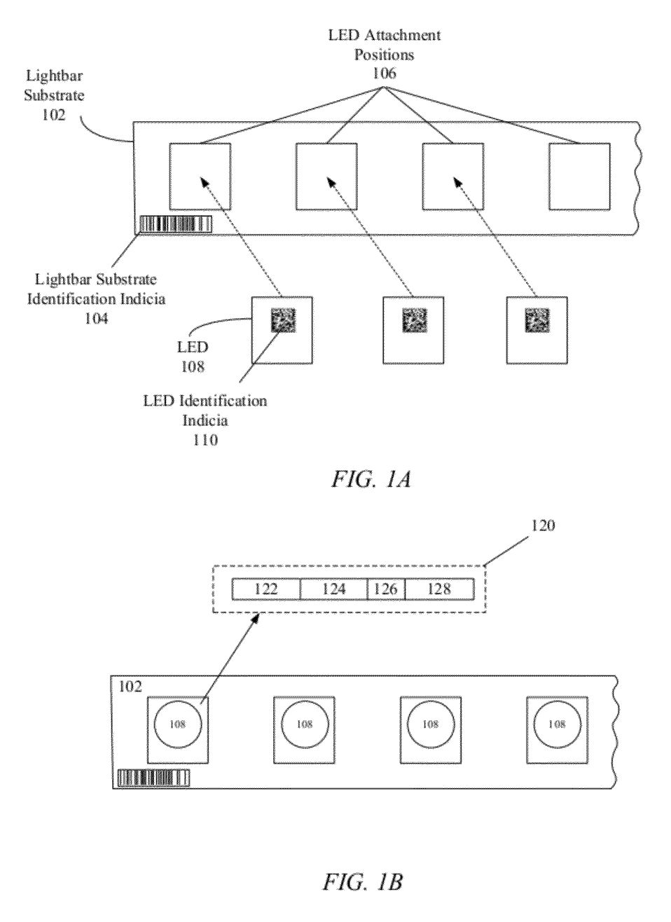

FIG. 1A shows a relationship between lightbar substrate 102 having lightbar identification indicia 104, LED attachment positions 106 in relation to LED 108 having LED identification indicia 110. Lightbar substrate identification indicia 104 can take the form of a bar code containing, for example, serial number information. Lightbar substrate 102 also contains a number of LED attachment positions 106, which can include a connection (not shown) for powering an LED 108. LED 108 includes LED identification indicia 110 on the attachment side of the LED. The LED identification indicia 110 can take the form of a 2D matrix barcode as shown, which contains at least the serial number of the LED.

FIG. 1B shows fully assembled lightbar 112 where each LED 108 is attached to lightbar substrate 102 at corresponding lightbar substrate attachment position 106. In the described embodiment, bundled data 120 includes information used to specifically identify particular LEDs in their respective positions on a particular lightbar substrate. In particular, bundled data 120 can include data components in the form of lightbar substrate identification information 122 associated with LED identification indicia 110, LED identification information 124 associated with LED identification indicia 110 and LED attachment position data 126 associated with LED attachment position on lightbar substrate 102. Optionally, bundled data 120 can also include carrier information 128. Carrier information 128 is generally located on the component manufacturer packaging, and can include information such as lot number (as shown), manufacturing line, or any other number of pertinent details. Bundled data 120 can be recorded on to a database in the form of a component tracking database.

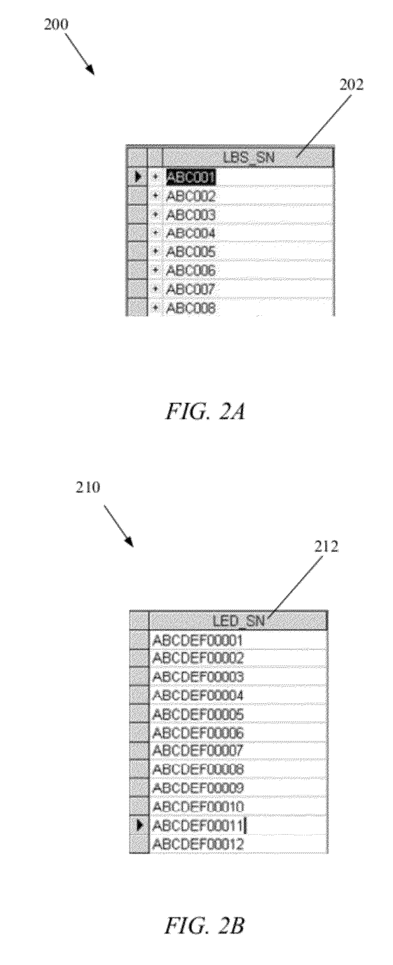

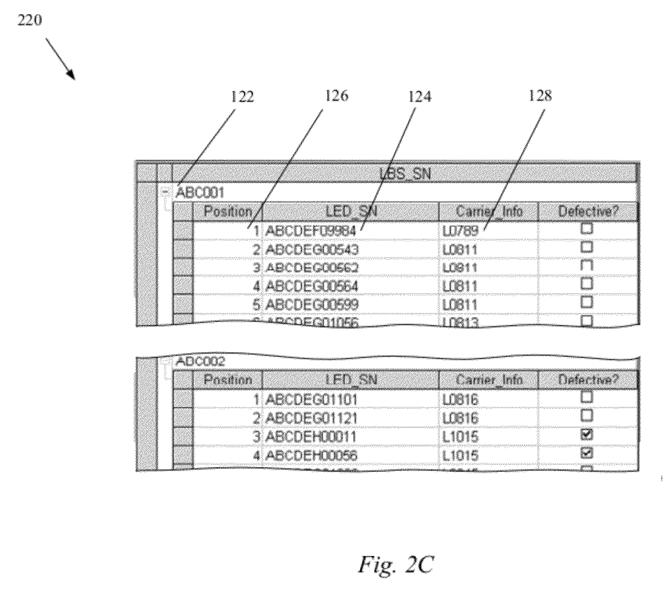

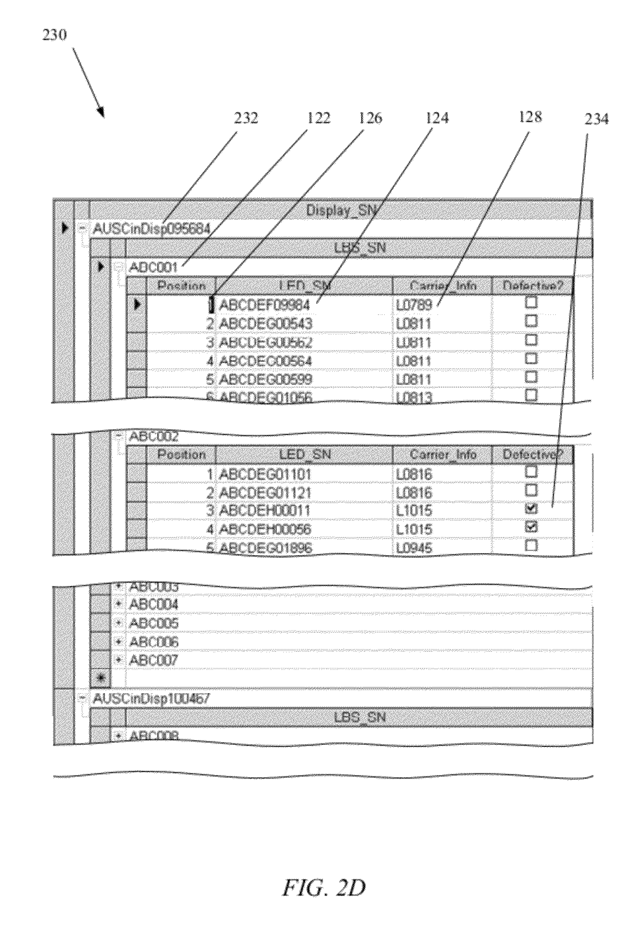

FIG. 2A shows representative database 200 used to store lightbar identification information 122 in accordance with the described embodiments. In particular, light bar information database 200 can be used to accumulate information for a plurality of lightbar substrates. For example, lightbar substrate identification information 122 can take the form of lightbar substrate serial number (LBS_SN) 202. In this way, information from many lightbar substrates can be easily accumulated for later use. For example, lightbar substrate information database 200 can include lightbar substrate serial numbers ABC001 through ABC008 each corresponding to a particular lightbar substrate.

Similarly, FIG. 2B shows representative database 210 used to store LED identification information 124 in accordance with the described embodiments. In particular, LED information database 210 can be used to accumulate information for a plurality of LEDs. For example, LED substrate identification information 124 can take the form of LED serial number (LED_SN) 212. In this way, information from many LEDs can be easily stored. For example, LED information database 210 can include LED serial numbers ABCDEF0001 through ABCDEF0012 each corresponding to a particular LED. It should be noted that a likely use of databases 200 and 210 would be for transitory storage of component information before each LED 108 is associated with lightbar substrate 102 in the component tracking database.

FIG. 2C shows representative component tracking database 220 in accordance with the described embodiments. In particular, component tracking database 220 can include information for completed lightbar assemblies, and shows the lightbar substrate identification information 124 in a hierarchical parent child (one lightbar substrate to many LEDs) relationship with the LED identification information 122. The information can be accumulated during an LED installation process in which individual LEDs are placed in specific locations on the light bar substrate. In this way, all components used to manufacture the light bar assembly can be traced back to their originating entity. This is particularly useful in those situations where during, for example, an outgoing quality check operation, one or more defective LEDs are discovered. By noting the locations of the defective LEDs, the component tracking database 220 can be queried to resolve specific LED lot or batch information in which other defective LEDs may be found.

FIG. 2D shows how the component tracking database 220 could be further linked to end products, such as, for example, a display unit in which the lightbars are installed. The display identification information 232 becomes the highest level with multiple lightbar substrate identification associated beneath it, and multiple LED identification information associated beneath each lightbar substrate. By recording the identification information of the lightbars as they are installed into the display, the recall of faulty LEDs becomes much easier. When the relational database structure depicted in FIG. 2D is employed, it allows all potentially defective LEDs to be flagged correlated directly to the associated display. For example, defective LED tracking column 234 allows the database to be queried for all displays containing an LED from an effected lot, in this case lot L1015. The manufacturer could then preemptively send out a recall notice with the specific serial numbers of every effected display, and even know how many of the lightbars in the effected displays need replacing. In the example case it appears that lightbar ABC002 needs replacing.

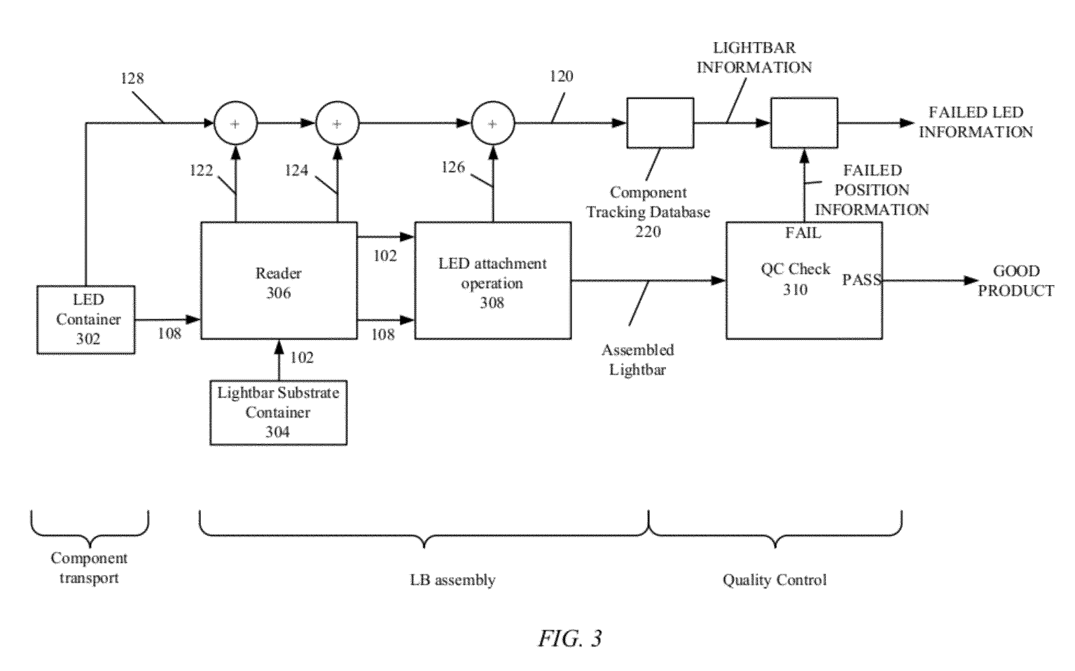

FIG. 3 shows system 300 for manufacturing and back tracing components in a manufacturing process that includes an outgoing quality check operation in accordance with the described embodiments. System 300 can include a number of synergistically arranged components. During an assembly operation, LED 108 can be received in LED container 302 and lightbar substrate 102 can be received in lightbar substrate container 304. In a reading and recording operation, reader 306 can obtain LED identification information 124 from LED 108 and lightbar identification information 122 from lightbar substrate 102. Concurrently, carrier information 128 is read and recorded from LED container 302. It should be noted that if the LED supplier has a known set of LEDs that were identified to be defective after LEDs shipped from the LED supplier to assembly, reader 306 can read the serial number and compare against a known list of bad LEDs and reject the LEDs identified from that list during production, saving recall and rework costs or even avoiding failures further downstream.

LED 108 is then attached to lightbar substrate 102 at LED attachment position 106 during LED attachment operation 308. The LED attachment position information 126 is recorded. Information stored in the recording process including substrate identification information 122, LED identification information 124, LED attachment position information 126, and carrier information 128 is all stored as bundled data 120 in component tracking database 220. Once the lightbar is complete quality control check 310 begins. If the lightbar passes quality control check 310 then it is passed on to a downstream assembly entity, if it fails quality control check 310, then LED attachment position information 126 of any defective LED 108 is combined with information from component tracking database 220 to determine LED identification information 124 of the defective LEDs. This information can be used in conjunction with associated carrier information 128 to back trace other potentially bad LEDs or even to evaluate component manufacturer quality trends.

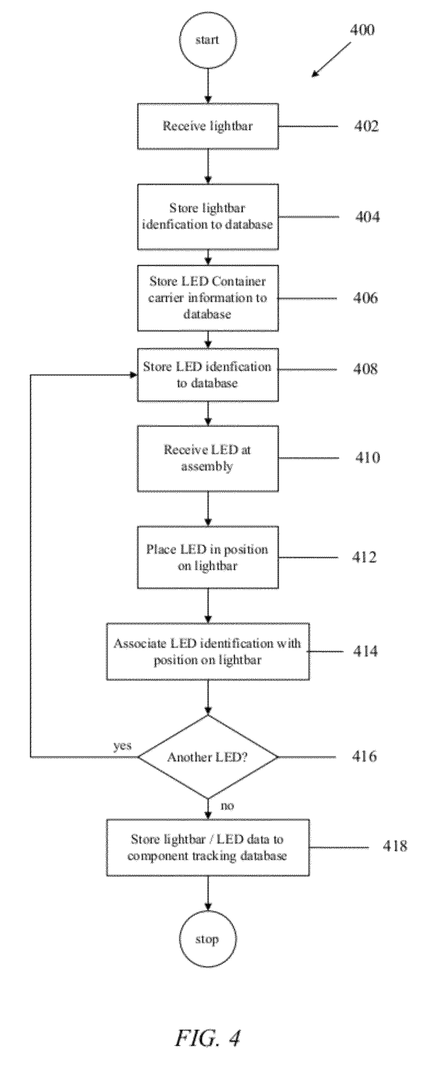

FIG. 4 shows a flowchart detailing process 400 for assembling a light bar in accordance with the described embodiments. Process 400 begins at 402 by receiving a lightbar from a manufacturer. At step 404 identification indicia on the lightbar is then read into the component tracking database. This will generally be performed by a machine configured to read a bar code that was affixed to the lightbar by the lightbar component manufacturer. At step 406 an LED container will be received from an LED component manufacturer and the carrier information from the LED container will be recorded to the component tracking database. LED containers can be embodied by reel containers. The reel is unraveled as each LED is received. The indicia on the back of the LED will be recorded into the component tracking database at 408 and received at lightbar assembly operation at 410. This will generally be done by a machine configured to read a 2D matrix barcode from the back of the LED that was affixed to it by the LED component manufacturer. The LED is then affixed to the lightbar at step 412, at which point the serial number and position on the lightbar of the LED are associated in a parent-child relationship with the serial number of the lightbar in the component tracking database at step 414. If the lightbar needs more LEDs step 416 resets the process to step 408, otherwise after the final LED is added and recorded the record for the lightbar is closed.

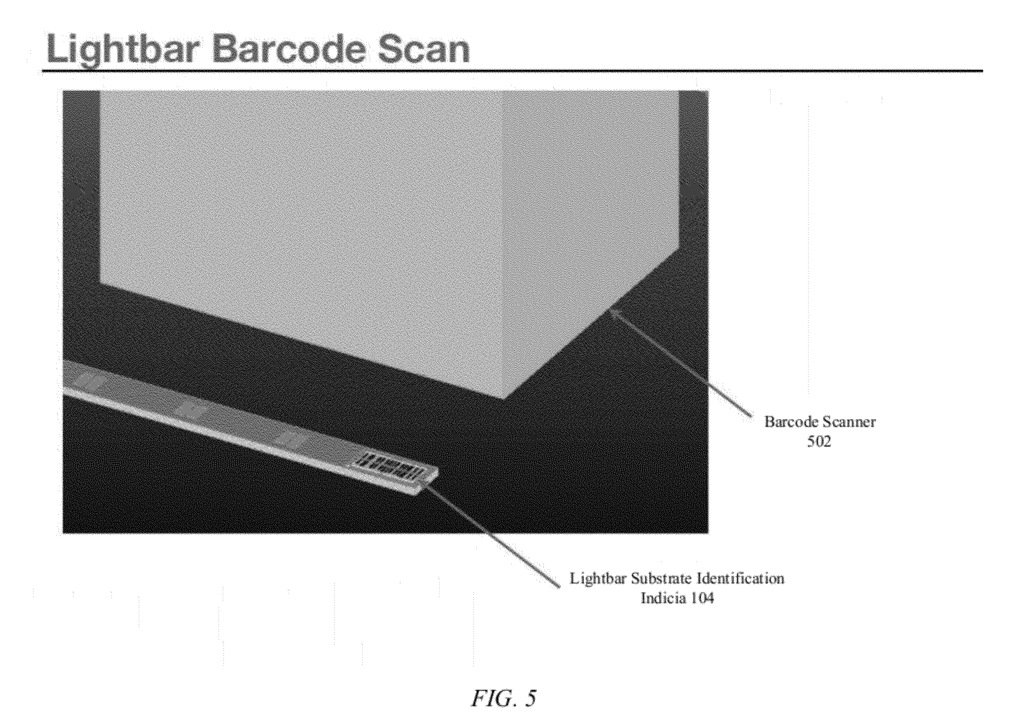

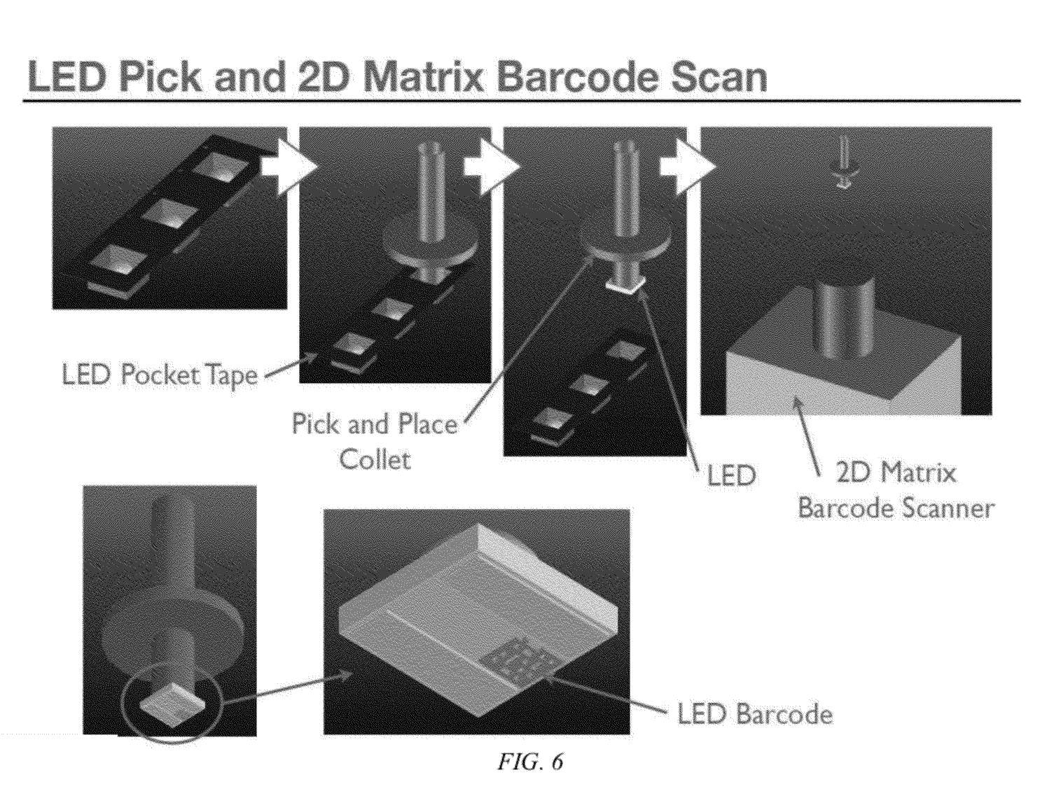

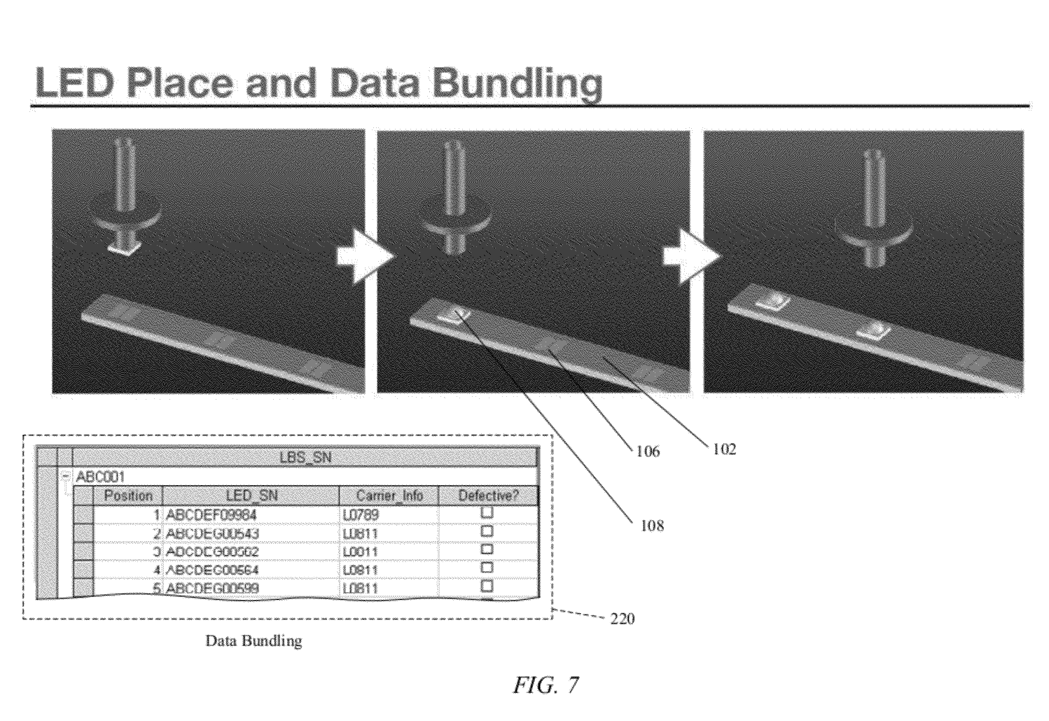

FIGS. 5-7 visualize the process of manufacturing and recording the subcomponent information of a lightbar into the component tracking database. In FIG. 5 the lightbar substrate identification indicia 104 is scanned by barcode scanner 502. In FIG. 6 LED pocket tape that component manufacturers typically pack LEDs in is shown. A pick and place collet is shown pulling an individual LED out of the LED pocket tape. The pick and place collet then takes the LED to a 2D matrix barcode scanner where the LED serial number is stored by the component tracking database. In FIG. 7 the pick and place is shown placing the LED onto a lightbar substrate, at which point LED attachment position 106 and LED identification indicia 110 are bundled with lightbar substrate serial number 104 into the component tracking database.

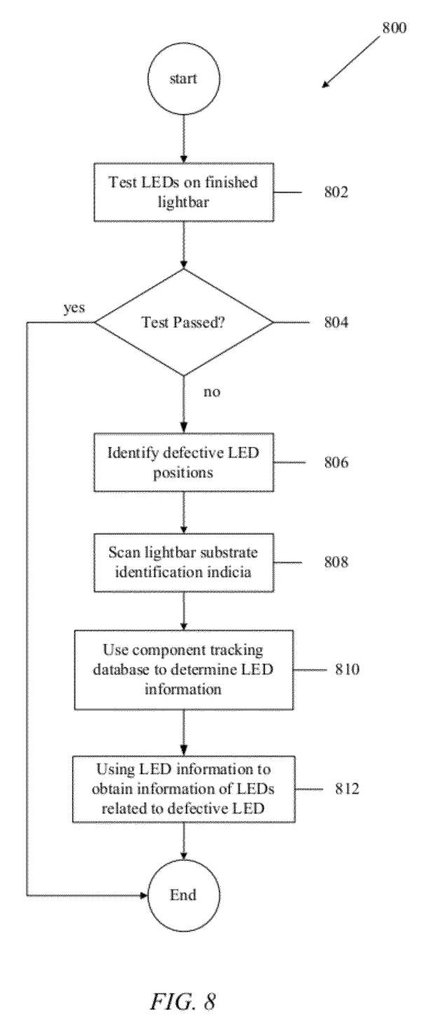

FIG. 8 shows a flowchart detailing process 800 for testing a completed lightbar after assembly. Process 800 for testing a lightbar begins at 802 by testing the LEDs on the finished lightbar. At 804 if the lightbar passes testing process 802 nothing more needs to be done; however, if at least one of the LEDs on the lightbar fails the testing process, failed LED position detection process 806 determines the position of the failed LED on the lightbar substrate. At 808 the lightbar substrate barcode is then scanned. At 810 the component tracking database receives both the failed LED position and the lightbar substrate serial number as inputs, and then determines the identification information of the defective LED. At step 812 the LED identification information is used to identify other LEDs from the same batch or lot that might also be defective. This allows quality control personnel to query the component tracking database periodically and quickly notify suppliers of problems with LED shipments. This information could also be used to remove batches of LEDs from the production line when LED batch failure rates exceed a predetermined threshold.

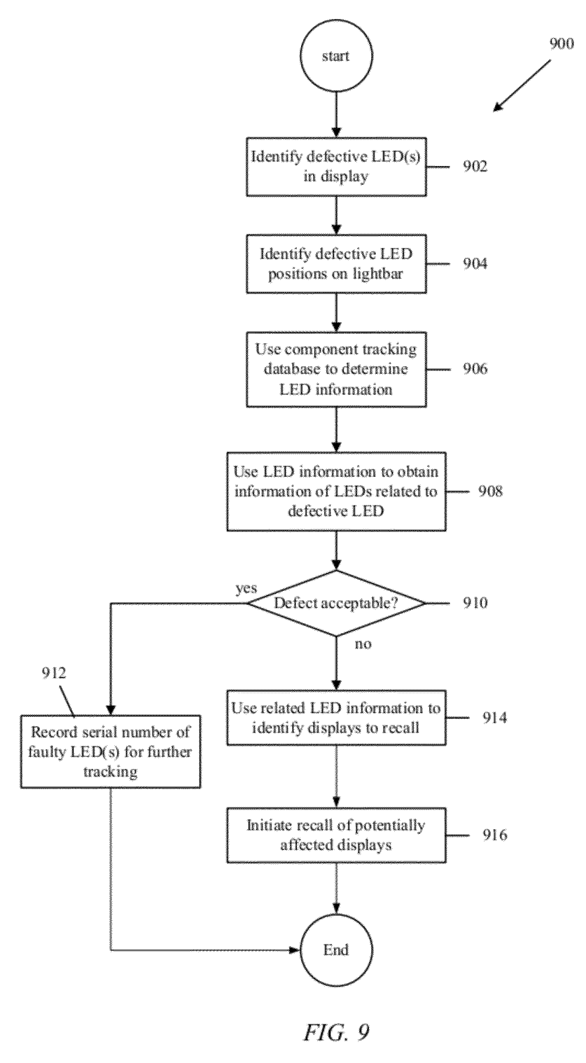

FIG. 9 shows a flowchart detailing a process 900 that could be implemented for deciding whether defective LED batches or lots are faulty enough to initiate a recall of associated products. Process 900 begins with step 902 where a defective LED is first discovered in a display. In steps 904 and 906 display identification information, lightbar identification information and defective LED position are gathered. This allows step 908 to use the component tracking database to determine the identification information of the LEDs that were affected. At 910 a defect analysis is conducted, using failure rates of other LEDs from the same batch or lot to determine whether or not the defect is common enough to initiate a recall. This step may require asking the associated component manufacturer questions about the affected lot or batch and conditions that may have caused the defect. If the defect occurrence frequency falls within an acceptable range, then the LED identification information is recorded in the component tracking database for further monitoring at 912, and the process ends. If, however the defect occurrence exceeds an acceptable threshold, then at step 914 the component tracking database is used to identify displays with LEDs from the same batch as the faulty LEDs. At step 916 a recall of potentially effected displays is initiated. This process could result in significant cost savings since, for example it allows for a very specific recall with a definite list of affected serial numbers, instead of being forced to recall every product produced during a specific time frame.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the invention. Thus, the foregoing descriptions of specific embodiments are presented for purposes of illustration and description. They are not intended to be exhaustive or to limit the invention to the precise forms disclosed. It will be apparent to one of ordinary skill in the art that many modifications and variations are possible in view of the above teachings.

What is claimed is:

1. A system for back tracing a component used in manufacture, comprising:
a processor;
a component information gathering device arranged to acquire component information during an assembly operation, the component information including component identification information and component origin information corresponding to the component;
a substrate information gathering device arranged to acquire substrate information during the assembly operation, the substrate information including substrate identification information corresponding to a substrate on which the component is attached during the assembly operation; and
a data storage device coupled to the component information gathering device and the substrate information gathering device and the processor, wherein during the assembly operation the processor,
instructs the component information gathering device to acquire the component information at least a portion of which is stored in the data storage device,
instructs the substrate information gathering device to acquire the substrate information associated with the substrate on which the component is attached at least a portion of which is stored in the data storage device, and
links the substrate information and the corresponding component information stored in the data storage device to form a data bundle, wherein the data bundle can be used to back trace the component subsequent to the completion of the assembly operation.

2. The system as recited in claim 1, wherein the component is a light emitting diode (LED) having at least an LED indicia associated therewith and wherein the substrate is a light bar substrate having a light bar substrate indicia associated therewith, wherein the LED indicia is associated with LED information for the associated LED and the substrate information for the corresponding light bar substrate.

3. The system as recited in claim 2, the LED indicia is an LED optical barcode and the light bar substrate indicia is a substrate optical barcode and wherein substrate information gathering device is an optical bar code reader arranged to read both the LED optical barcode and the substrate optical barcode to extract the LED information and the substrate information for storage in the data storage device.

4. The system as recited in claim 3, further comprising:
an LED attachment mechanism arranged to bond the LED to a pre-defined physical location on the light bar substrate and electrically attach the LED to a pre-defined electrical network embedded in the substrate at the pre-defined physical location to form a light bar assembly, wherein the LED attachment mechanism passes physical location information and substrate information to a component tracking database.

5. The system as recited in claim 4, further comprising:
an outgoing testing component arranged to receive the light bar assembly, functionally test the light bar assembly, and if the function testing determines the light bar assembly does not pass a pre-defined outgoing quality check, then pass position information of at least one failed LED to a failure database.

6. The system as recited in claim 5, wherein the position information of the at least one failed LED in the failure database is correlated to information included in the component tracking database to identify source information of the failed LEDs.

7. A method for using identification of a defective display element in a light bar assembly in a display device for issuing a recall notice, comprising:
receiving information of a light bar assembly having at least one defective display element attached thereto, the information including a physical location of the defective display element, the information including display element information and light bar information;
using the received information to query a component tracking database to obtain defective display element information;
using the defective display element information to obtain information of display elements related to the defective display element;
using the related display element information to identify at least another display device having at least one related display element included therein;
determining a defect mode of the defective display element; and
issuing the recall notice to the at least another display device of the presence of the identified related display element only when the defect mode is determined to be unacceptable.

8. The method as recited in claim 7, wherein when the defect mode is acceptable, then recording the defective display element information and the associated defect mode in a defect mode database for further processing.

9. The method as recited in 7, further comprising:
using the defect mode database to characterize a quality level of at least one display device manufacturer.

10. The method as recited in claim 7, further comprising:
using the defect mode database to characterize a light bar assembler quality level.

11. An assembly method, comprising:
receiving at least one substrate and at least one component for mounting upon the substrate;
acquiring component information that includes at least identification information and component origin information corresponding to the component;
acquiring substrate information including substrate identification information;
passing at least some of the acquired information to a data store;
attaching the component to the substrate at a pre-defined location on the substrate;
passing pre-defined location information to the data store;
linking the substrate information and the pre-defined location information to form a data bundle, wherein the data bundle can be used to back trace the component subsequent to the completion of the assembly method.

12. The method as recited in claim 11, wherein the component is a light emitting diode (LED) having at least an LED indicia associated therewith and wherein the substrate is a light bar substrate having a light bar substrate indicia associated therewith, wherein the LED indicia is associated with LED information for the associated LED and the substrate information for the corresponding light bar substrate.

13. The method as recited in claim 12, the LED indicia is an LED optical barcode and the light bar substrate indicia is a substrate optical barcode and wherein substrate information gathering device is an optical bar code reader arranged to read both the LED optical barcode and the substrate optical barcode to extract the LED information and the substrate information for storage in the data storage device.

14. The method as recited in claim 13, further comprising:
an LED attachment mechanism arranged to bond the LED to a pre-defined physical location on the light bar substrate and electrically attach the LED to a pre-defined electrical network embedded in the substrate at the pre-defined physical location to form a light bar assembly, wherein the LED attachment mechanism passes physical location information and substrate information to a component tracking database.

15. The method as recited in claim 14, further comprising:
an outgoing testing component arranged to receive the light bar assembly, functionally test the light bar assembly, and if the function testing determines the light bar assembly does not pass a pre-defined outgoing quality check, then pass position information of at least one failed LED to a failure database.

16. Non-transitory computer readable medium for storing computer code executable by a processor for using identification of a defective display element in a light bar assembly in a display device for issuing a recall notice, comprising:
computer code for receiving information of a light bar assembly having at least one defective display element attached thereto, the information including a physical location of the defective display element, the information including display element information and light bar information;
computer code for using the received information to query a component tracking database to obtain defective display element information;
computer code for using the defective display element information to obtain information of display elements related to the defective display element;
computer code for using the related display element information to identify at least another display device having at least one related display element included therein;
computer code for determining a defect mode of the defective display element; and
computer code for issuing the recall notice to the at least another display device of the presence of the identified related display element only when the defect mode is determined to be unacceptable.

17. The computer readable medium as recited in claim 16, wherein when the defect mode is acceptable, then recording the defective display element information and the associated defect mode in a defect mode database for further processing.

18. The computer readable medium as recited in 16, further comprising:
computer code for using the defect mode database to characterize a quality level of at least one display device manufacturer.

19. The computer readable medium as recited in claim 7, further comprising:
computer code for using the defect mode database to characterize a light bar assembler quality level.

20. The computer readable medium as recited in claim 15, wherein the position information of the at least one failed LED in the failure database is correlated to information included in the component tracking database to identify source information of the failed LEDs.

21. An assembly apparatus, comprising:
means for receiving at least one substrate and at least one component for mounting upon the substrate;
means for acquiring component information that includes at least identification information and component origin information corresponding to the component;
means for acquiring substrate information including substrate identification information;
means for passing at least some of the acquired information to a data store;
means for attaching the component to the substrate at a pre-defined location on the substrate;
means for passing pre-defined location information to the data store;
means for linking the substrate information and the pre-defined location information to form a data bundle, wherein the data bundle can be used to back trace the component subsequent to the completion of the assembly method.

22. The assembly apparatus as recited in claim 21, wherein the component is a light emitting diode (LED) having at least an LED indicia associated therewith and wherein the substrate is a light bar substrate having a light bar substrate indicia associated therewith, wherein the LED indicia is associated with LED information for the associated LED and the substrate information for the corresponding light bar substrate.

23. The assembly apparatus as recited in claim 22, the LED indicia is an LED optical barcode and the light bar substrate indicia is a substrate optical barcode and wherein substrate information gathering device is an optical bar code reader arranged to read both the LED optical barcode and the substrate optical barcode to extract the LED information and the substrate information for storage in the data storage device.

24. The assembly apparatus as recited in claim 23, further comprising:
an LED attachment mechanism arranged to bond the LED to a pre-defined physical location on the light bar substrate and electrically attach the LED to a pre-defined electrical network embedded in the substrate at the pre-defined physical location to form a light bar assembly, wherein the LED attachment mechanism passes physical location information and substrate information to a component tracking database.
